(19) United States
(12) Patent Application Publication
(10) Pub. No.: US 2010/0079239 A1
(43) Pub. Date: Apr. 1, 2010

(54) Repurposing User Identity Tokens

(76) Inventors: Riddhiman Ghosh, Sunnyvale, CA (US); Keith E. Moore, Sunnyvale, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/240,882

(22) Filed: Sep. 29, 2008

(51) Int. Cl. G08B 29/00

(52) U.S. Cl. 340/5.21

(57) ABSTRACT

An exemplary method for repurposing user identity tokens comprises receiving identification information from a user, the user having an existing user identity token and seeking to repurpose the token, obtaining a repurpose identifier associated with the user, enabling a configuration of an identification tag based on the repurpose identifier, and associating the identification tag with the identity token.

### BACKGROUND

For security or other reasons, many businesses issue identity tokens to personnel authorized for ingress to and egress from buildings or for access to certain rooms within a building. Identity tokens may also be issued for other reasons. For example, users may need identity tokens to gain access to a system, a device, equipment, a software application, specific data files, and so forth.

Authorization data, which may include levels of access privileges for different users, are typically stored as an access control list (ACL) in a database. The authorization data are modifiable by accessing the database to modify one or more ACLs or the database schemas (e.g., to create additional authorization levels). In addition, existing applications may have to be revised or rewritten to accept new identification information.

In many situations, a user may wish to repurpose his user identity token. For example, the user may wish to modify the authorization data to comply with a new rule, gain access to a new application, or make the token compatible with a hardware device. Accessing an ACL database each time a need to repurpose a token arises can be inefficient.

Thus, a market exists for a method and system to repurpose user identity tokens.

### SUMMARY

An exemplary method for repurposing user identity tokens comprises receiving identification information from a user (the user having an existing user identity token and seeking to repurpose the token), obtaining a repurpose identifier associated with the user, enabling a configuration of an identification tag based on the repurpose identifier, and associating the identification tag with the user identity token.

Other embodiments and implementations are also described below.

### BRIEF DESCRIPTION OF THE FIGURES

FIG. 1 illustrates an exemplary system for repurposing user identity tokens.

FIG. 2 illustrates an exemplary repurposed user identity token.

FIG. 3 illustrates an exemplary process for repurposing user identity tokens.

FIG. 4 illustrates an exemplary process for repurposing a user identity token when adding a new rule.

FIG. 5 illustrates an exemplary process for repurposing a user identity token to enable access to a new application.

FIG. 6 illustrates an exemplary process for repurposing a user identity token to make the token compatible with existing hardware capabilities.

FIG. 7 illustrates an exemplary process for reading a repurposed user identity token.

### DETAILED DESCRIPTION

### I. Overview

Exemplary processes and systems for repurposing user identity tokens are described.

Section II describes an exemplary system for repurposing user identity tokens.

Section III describes an exemplary process for repurposing user identity tokens.

Section IV describes exemplary implementations for repurposing user identity tokens.

Section V describes an exemplary process for reading a repurposed user identity token.

Section VI describes an exemplary computing environment.

### II. An Exemplary System for Repurposing User Identity Tokens

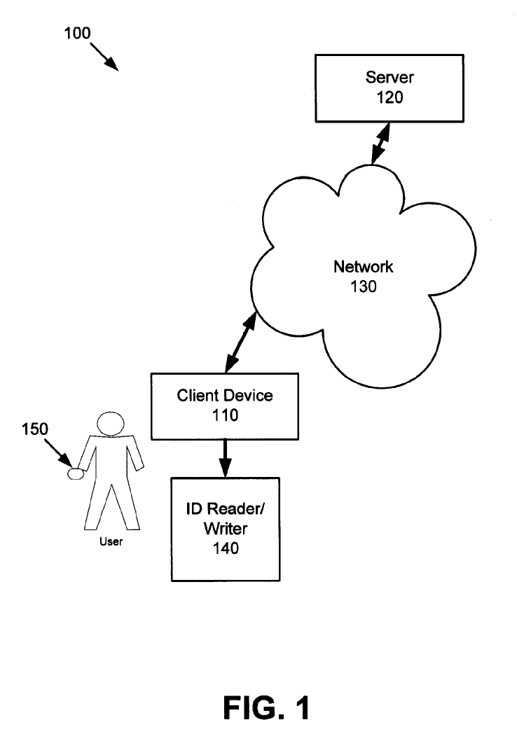

FIG. 1 illustrates an exemplary system 100 for repurposing user identity tokens. The exemplary system 100 includes a client device 110 connected to a server 120 over a network 130. The client device 110 may be any computing device having software applications that enable the client device 110 to communicate to the server 120 over a communication network (e.g., an intranet, the Internet, etc.).

The server 120 may reside in a single computing device or multiple computing devices connected in a network (e.g., a distributed network). In another exemplary implementation, the client 110 and server 120 may be separated logically (e.g., can be physically located in the same device and without any explicit network connection). In an exemplary implementation, the server 120 includes an interface for obtaining information from and sending information to client devices and a processor for generating or obtaining repurpose identifiers.

The exemplary system 100 further includes an identifier reader and writer (ID RW) 140 accessible to the client device 110. In an exemplary implementation, the ID RW 140 is a portable device that can function on its own or work with any computing device, for example, via a USB port. An identifier may be a digital certificate, a cryptographic signature, and/or other digital identification. In an exemplary implementation, the identifier can be stored on a near-field or proximity radio-frequency identification (NFID or RFID) tag. In this exemplary implementation, the ID RW 140 is configured to write identifiers (e.g., received from a server 120) onto a near-field identification tag and read identifiers on a near-field identification tag.

A user having a user identity token 150, such as a badge, may submit a request to repurpose the identity token 150 at the client device 110. The client device 110 sends the request to the sever 120 over the network 130. The server 120 generates (or otherwise obtains) a repurpose identifier and sends the repurpose identifier back to the client device 110 or any other suitable device (e.g., the ID RW). The repurpose identifier may be implemented as any digital identifier. The user, the client device 110, or any other authorized entity, may instruct the ID RW to write the repurpose identifier onto an identification (ID) tag (e.g., a near-field identification tag). In an exemplary implementation, the ID tag is cryptographically associated with the identity token 150. In an exemplary implementation, once cryptographically associated with one token, the identification tag may not be used with any other identity tokens. The ID tag may have been previously affixed or imprinted on the identity token 150 or may be affixable to the identity token 150. For example, the ID tag may be associated with the identity token by affixing the ID tag onto the identity token (e.g., by adhesion, etc.). In an exemplary implementation, a repurpose identifier may be generated by associating an existing identifier (e.g., a unique identifier pre-assigned to an ID tag by the tag manufacturer) to data associated with the repurpose being sought. In this implementation, a user will not need to write an identifier onto an ID tag at the client device 110. Thus, the device 140 may simply be an ID reader and the ID tag may be a read-only tag.

Based on the above exemplary process, the user identity token 150 can be swiftly repurposed to comply with a new rule (e.g., new authorization levels), gain access to a new application, or for other purposes. Enabling a user to associate an ID tag containing a new identifier onto an existing identity token vitiates the need to access secured databases for purposes of modifying authentication or authorization data encoded in the existing token.

In accordance with current industry standards, many ID tags can be configured to store multiple identifiers for multiple purposes. For example, NFID tags can be configured to store multiple near-field identifiers. Near-field identification is one type of radio-frequency identification and is well known in the art. Exemplary near-field identification standards include, without limitation, ISO 15693 and ISO 14443.

Similarly, many different types of ID tags are known and can be implemented to repurpose an identity token depending on design choice. Storage capacity in each ID tag varies depending on design choice. For example, the storage capacity of a tag can range from 64 bits to 2 kilobytes or more. The tags can be implemented as powered tags or passive tags.

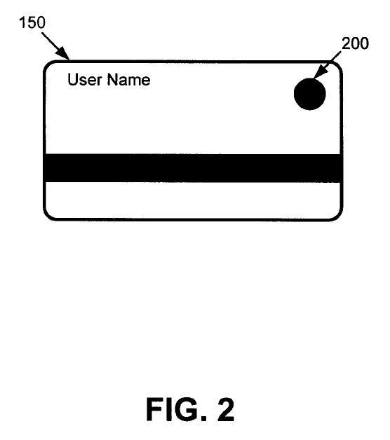

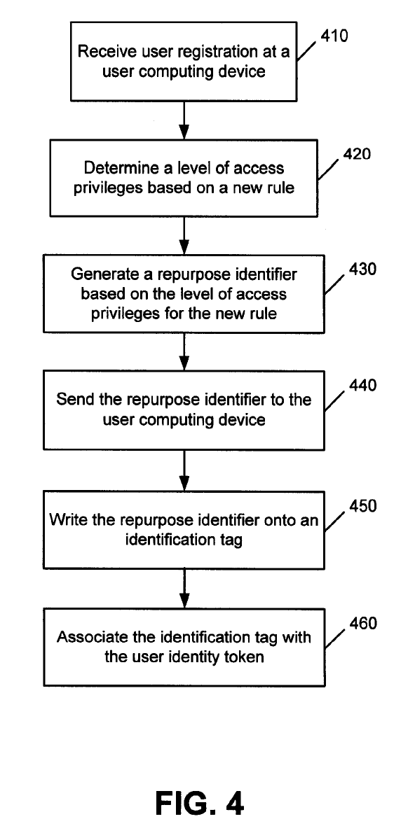

FIG. 2 illustrates an exemplary user identity token, such as a badge 150. Typically, a badge 150 has the name of the user imprinted on it and a bar strip containing data (e.g., identification data) related to the user. In accordance with an exemplary implementation, an ID tag 200 is associated with the badge. For example, the ID tag 200 may be cryptographically associated with the badge. In another example, the ID tag 200 can be affixed onto the badge (e.g., by imprint, by adhesion, etc.). In yet another example, the ID tag 200 may be both cryptographically associated and affixed onto the badge. As a result, the badge can be repurposed to enable a user to use the badge for other purposes than the original purposes enabled by the bar strip. Exemplary repurposes will be described below with reference to FIGS. 4-6.

### III. An Exemplary Process for Repurposing User Identity Tokens

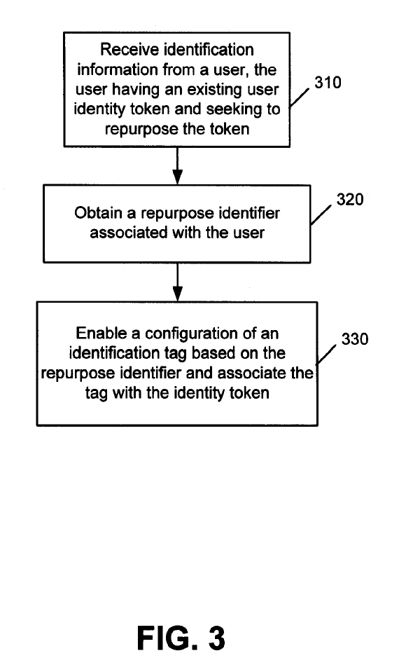

FIG. 3 illustrates an exemplary process for repurposing a user identity token.

At step 310, the server 120 receives identification information from a user. The user has an existing user identity token and seeks to repurpose the token.

At step 320, the server 120 obtains a repurpose identifier associated with the user. In an exemplary implementation, the server 120 retrieves an identifier from a database or from a third party (e.g., using a pre-existing unique identifier assigned by a tag manufacturer). In another exemplary implementation, the server 120 generates a repurpose identifier using any identifier generation technology known in the art. The server 120 sends the repurpose identifier to a client device 110.

At step 330, the client device 110 is enabled to configure an ID tag based on the repurpose identifier. In an exemplary implementation, the client device 110 or the user may instruct an ID RW device 140 to write the repurpose identifier onto an ID tag. The ID tag is associated with the existing user identity token. In an exemplary implementation, the ID tag may be cryptographically associated with the identity token. In this implementation, the ID tag may or may not have been previously attached to the user identity token. In another exemplary implementation, the ID tag may be associated with the identity token by affixing the ID tag to the user identity token.

The process described above with reference to FIG. 3 is merely exemplary. A person skilled in the art will recognize that other process steps may be implemented to repurpose a user identity token using an ID tag. For example, depending on specific implementation, the steps of configuring an ID tag and affixing the ID tag onto a user identity token may be reversed. That is, a user may already have an ID tag on the existing identity token and is seeking to repurpose the tag or add a new purpose to the existing tag. Further, depending on design choice, each ID tag can be enabled to accept multiple repurpose identifiers for multiple purposes.

Three exemplary implementations will be described below with reference to FIGS. 4, 5 and 6. One skilled in the art will recognize that other implementations are possible for repurposing user identity tokens to suit other needs.

### IV. Exemplary Implementations

### A. Example 1

FIG. 4 illustrates an exemplary implementation wherein a user is requesting to repurpose an identity token to comply with a new rule. In this example, the new rule defines new user identification requirements. For example, a company may already have manager level and employee level privileges but now an application needs additional authorization levels (e.g., an intermediate “auditor” level of privileges).

At step 410, a user registers at a user computing device (e.g., the client device 110). For example, the user may fill out a registration form and submit the information electronically after completion. Alternatively, a user may log-in to an existing account using a computing device connected to the server 120 via the communication network 130.

At step 420, a proper level of access privileges is determined by the application based on a new rule. For example, the files and devices that are accessible to an auditor are determined.

At step 430, a repurpose identifier is generated (e.g., by the server 120) based on the level of access privileges and in accordance with the new rule.

At step 440, the repurpose identifier is sent to the user computing device over a communication network.

At step 450, the repurpose identifier is written onto an ID tag. For example, the ID tag may be a near-field ID tag and an ID RW device 140 may be used to write the identifier onto the near-field ID tag.

At step 460, the ID tag is associated with the identity token. For example, the ID tag may be affixed onto and/or cryptographically associated with the user identity token. As a result, a user who is an auditor can gain access privileges suitable for his level by repurposing his existing user identity token. An application is enabled to create different authorization levels without changing systems of record, ACLs, or affecting other existing applications.

### B. Example 2

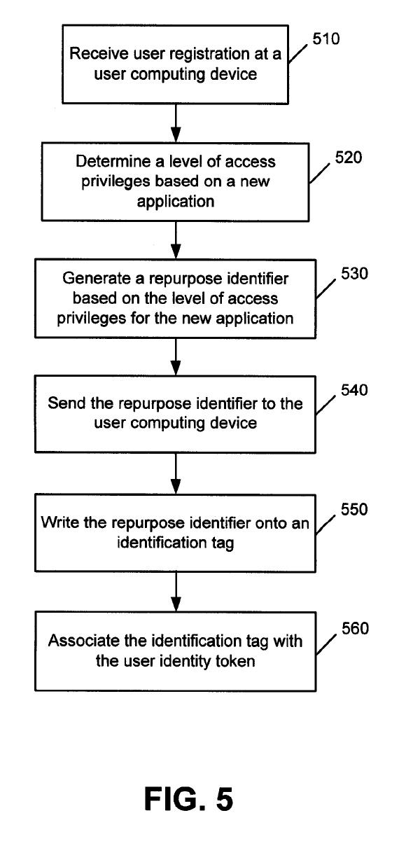

FIG. 5 illustrates an exemplary implementation wherein a user is requesting to repurpose an identity token to gain access to a new application. In this example, the new application is a secure printing application.

At step 510, a user registers at a user computing device (e.g., the client device 110). For example, the user may fill out a registration form and submit the information electronically after completion. Alternatively, the user may log-in to an existing account using a computing device connected to the server 120 via the communication network 130.

At step 520, a proper level of access privileges is determined based on the policy of the new secure printing application.

At step 530, a repurpose identifier is generated (e.g., by the server 120) based on the level of access privileges in accordance with a policy of the new application.

At step 540, the repurpose identifier is sent to the user computing device over a communication network.

At step 550, the repurpose identifier is written onto an ID tag. For example, an ID RW device 140 may be used to write the identifier onto a physical tag.

At step 560, the ID tag is associated with the user identity token. For example, the ID tag may be affixed onto and/or cryptographically associated with the user identity token.

As a result, a user can gain access privileges to a new secure printing application by repurposing his existing user identity token.

### C. Example 3

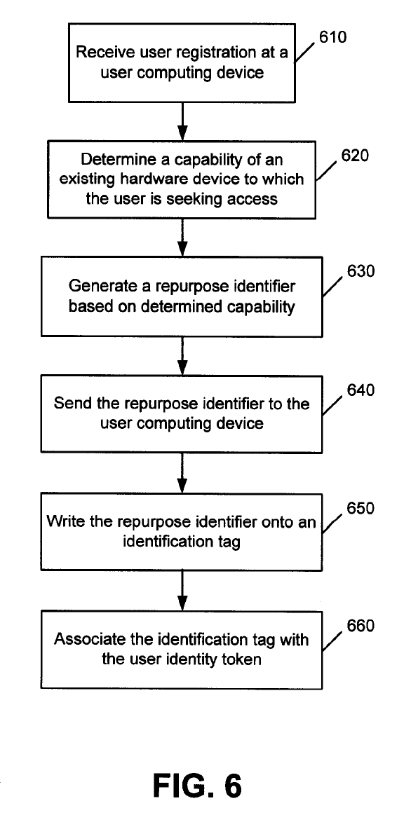

FIG. 6 illustrates an exemplary implementation wherein a user is requesting to repurpose an identity token to make it compatible with the capability of an existing hardware device. For example, a printer may not have a badge reading device or may have a badge reading device that is unable to read the user's badge.

At step 610, a user registers at a user computing device (e.g., the client device 110). For example, the user may fill out a registration form and submit the information electronically after completion. Alternatively, a user may log-in to an existing account using a computing device connected to the server 120 via the communication network 130. In this example, the user is seeking access to a hardware device which is unable to read the user's existing identity token.

At step 620, the capability of the hardware device at issue is determined based on the registration information. For example, the server 120 may determine that the printer is able to read identifiers from near-field identification tags but not badges because the printer does not have a badge reader or the printer has a badge reader that is incompatible with the user's badge.

At step 630, a repurpose identifier is generated (e.g., by the server 120) based on the capability of the hardware device at issue.

At step 640, the repurpose identifier is sent to the user computing device over a communication network.

At step 650, the repurpose identifier is written into an ID tag. For example, an ID RW device 140 may be used to write the identifier onto a physical tag.

At step 660, the ID tag is associated with the user identity token. For example, the ID tag may be affixed onto and/or cryptographically associated with the user identity token.

As a result, a user is now able to access the printer using his user identity token.

### V. An Exemplary Process for Reading a Repurposed User Identity Token

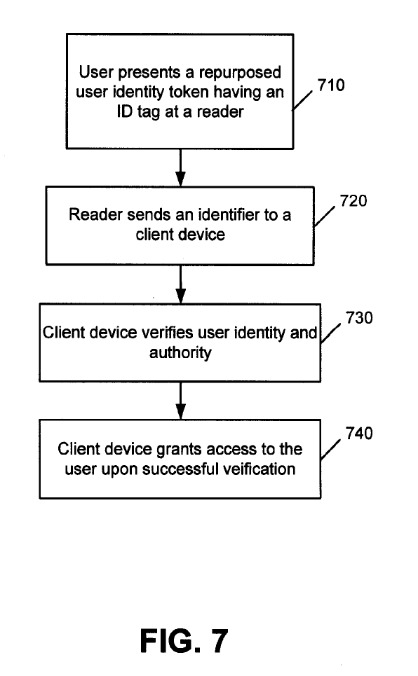

FIG. 7 illustrates an exemplary process for reading a repurposed user identity token.

At step 710, a user presents a repurposed user identity token having an affixed ID tag to a reader (e.g., an ID reader 140).

At step 720, the reader reads an identifier from the ID tag and sends the identifier to a client device 110.

At step 730, the client device 110 verifies user identity and authority based on the identifier. In an exemplary implementation, the client device 110 sends a verification request to the server 120 via the network 130. In another exemplary implementation, the client device 110 may look up verification data in a local database.

At step 740, upon successful verification, the client device 110 grants the user access.

### VI. An Exemplary Computing Environment

The techniques described herein can be implemented using any suitable computing environment. The computing environment could take the form of software-based logic instructions stored in one or more computer-readable memories and executed using a computer processor. Alternatively, some or all of the techniques could be implemented in hardware, perhaps even eliminating the need for a separate processor, if the hardware modules contain the requisite processor functionality. The hardware modules could comprise PLAs, PALs, ASICs, and still other devices for implementing logic instructions known to those skilled in the art or hereafter developed.

In general, then, the computing environment with which the techniques can be implemented should be understood to include any circuitry, program, code, routine, object, component, data structure, and so forth, that implements the specified functionality, whether in hardware, software, or a combination thereof. The software and/or hardware would typically reside on or constitute some type of computer-readable media which can store data and logic instructions that are accessible by the computer or the processing logic. Such media might include, without limitation, hard disks, floppy disks, magnetic cassettes, flash memory cards, digital video disks, removable cartridges, random access memories (RAMs), read only memories (ROMs), and/or still other electronic, magnetic and/or optical media known to those skilled in the art or hereafter developed.

### VII. CONCLUSION

The foregoing examples illustrate certain exemplary embodiments from which other embodiments, variations, and modifications will be apparent to those skilled in the art. The inventions should therefore not be limited to the particular embodiments discussed above, but rather are defined by the claims. Furthermore, some of the claims may include alphanumeric identifiers to distinguish the elements and/or recite elements in a particular sequence. Such identifiers or sequence are merely provided for convenience in reading, and should not necessarily be construed as requiring or implying a particular order of steps, or a particular sequential relationship among the claim elements.

What is claimed is:

1. A method for repurposing user identity tokens, comprising:
receiving identification information from a user, said user having an existing user identity token and seeking to repurpose said token;
obtaining a repurpose identifier associated with said user; and
enabling a configuration of an identification tag based on said repurpose identifier, said identification tag being associated with said user identity token.

2. The method of claim 1, wherein said associating with said user identity token includes cryptographically associating said identification tag to said identity token.

3. The method of claim 1, wherein said associating with said user identity token includes enabling a user to affix said identification tag to said identity token.

4. The method of claim 3, wherein said identification tag cannot be used with another identity token once cryptographically associated with said identity token.

5. The method of claim 1, wherein said repurpose includes compliance with a rule.

6. The method of claim 1, wherein said repurpose includes access to an application.

7. The method of claim 1, wherein said repurpose includes compliance with existing hardware capabilities.

8. The method of claim 1, wherein enabling a configuration includes digitally writing said repurpose identifier onto said identification tag.

9. The method of claim 1, wherein said identification tag is a near-field radio-frequency identification tag.

10. A server for repurposing user identity tokens, comprising:
an interface for receiving identification information from a user, said user having an existing user identity token and seeking to repurpose said token; and
a processor for generating a repurpose identifier associated with said user;
said interface being further configured to send said repurpose identifier to a client computing device capable of configuring, based on said repurpose identifier, an identification tag and said tag being associated with said identity token.

11. The server of claim 10, wherein said associating with said identity token includes cryptographically associating said identification tag to said identity token.

12. The server of claim 10, wherein said associating with said identity token includes enabling a user to affix said identification tag to said existing identity token.

13. The server of claim 10, wherein said identification tag cannot be used with another identity token once cryptographically associated with said identity token.

14. The system of claim 10, wherein said identification tag is a near-field radio-frequency identification tag.

15. A computer-readable storage medium for repurposing user identity tokens, comprising logic instructions that, if executed:
receive identification information from a user, said user having an existing user identity token and seeking to repurpose said token;
obtain a repurpose identifier associated with said user; and
enable a configuration of an identification tag based on said repurpose identifier, said tag being associated with said identity token.

16. The computer-readable storage medium of claim 15, wherein said associating with said identity token includes cryptographically associating said identification tag to said identity token.

17. The computer-readable storage medium of claim 16, wherein said identification tag cannot be used with another identity token once cryptographically associated with said identity token.

18. The computer-readable storage medium of claim 15, wherein said associating with said identity token includes enabling a user to affix said identification tag to said existing identity token.

19. The computer-readable storage medium of claim 15, wherein said instructions to obtain includes instructions that, if executed, generate a repurpose identifier at least based on said identification information.

20. The computer-readable storage medium of claim 15, wherein said identification tag is a near-field radio-frequency identification tag.
